(19) United States
(12) Patent Application Publication
(10) Pub. No.: US 2024/0411833 A1
(43) Pub. Date: Dec. 12, 2024

(54) ARCHITECTURE FOR NUMBER THEORETIC TRANSFORM AND INVERSE NUMBER THEORETIC TRANSFORM

(71) Applicant: Microsoft Technology Licensing, LLC, Redmond, WA (US)

(72) Inventors: Mojtaba Bisheh Niasar, Ithaca, NY (US); Bharat S. Pillilli, El Dorado Hills, CA (US)

(21) Appl. No.: 18/206,996

(22) Filed: Jun. 7, 2023

(51) Int. Cl. G06F 17/14; G06F 7/50; G06F 7/523; G06F 7/76

(52) U.S. Cl. CPC G06F 17/142; G06F 7/50; G06F 7/523; G06F 7/76

(57) ABSTRACT

Generally discussed herein are devices, systems, and methods for circuits that convert coefficients of a polynomial into or out of number theoretic transform (NTT) domain. A device can include butterfly operator circuits situated in parallel and to receive coefficients of a polynomial. The device can include a rearrange circuit configured to receive output of the butterfly operator circuits and route the output to input of the butterfly operator circuits. The device can include a memory situated to receive coefficients corresponding to the polynomial in a different domain that are output from the rearrange circuit.

### BACKGROUND

The advent of quantum computers poses a serious challenge to the security of the existing public-key cryptosystems, as they can be potentially broken based on Shor's algorithm. Lattice-based cryptosystems are among the most promising post-quantum cryptography (PQC) algorithms that are believed to be hard for both classical and quantum computers to break.

### SUMMARY

A method, device, or a machine-readable medium for synthesizable hardware circuits that transform coefficients of a polynomial into or out of a number theoretic transform (NTT) domain. A device can include butterfly operator circuits situated in parallel and to receive coefficients of a polynomial. The device can include a rearrange circuit configured to receive output of the butterfly operator circuits and route the output to input of the butterfly operator circuits. The device can further include a memory situated to receive coefficients corresponding to the polynomial in a different domain that are output from the rearrange circuit.

The different domain can include number theoretic transform (NTT) domain or inverse NTT (INTT) domain. Each of the butterfly operator circuits can further include a first register configured to provide a first coefficient. Each of the butterfly operator circuits can further include a second register configured to provide a second coefficient. Each of the butterfly operator circuits can further include a third register configured to provide a twiddle factor.

There can n polynomial coefficients and n/2 butterfly operator circuits. The rearrange circuit can rearrange the output differently for different iterations of operating the butterfly operator circuits.

The butterfly operator circuits can each comprise an adder, a subtractor, and a multiplier. The butterfly operator circuits can each comprise a first multiplexer that, when a control signal is set to NTT mode, provides the second coefficient and, when the control signal is set to inverse NTT (INTT) mode, provides a difference between the first coefficient and the second coefficient. The butterfly operator circuits can each comprise a second multiplexer that, when the control signal is set to the NTT mode, provides a result of multiplying the second coefficient by the twiddle factor and then subtracting the first coefficient and, when the control signal is set to inverse NTT (INTT) mode, provides a result that is a difference between the first coefficient and the second coefficient and then multiplying the difference by the twiddle factor. The butterfly operator circuits each comprise a third multiplexer that, when the control signal is set to NTT mode, provides a result of multiplying the second coefficient by the twiddle factor and then adding the first coefficient and, when the control signal is set to inverse NTT (INTT) mode, provides a result of adding the first coefficient and the second coefficient.

A method, machine-readable medium, or system can be configured to implement operations of the device or include components of the device, among other additional or alternative functionality or components.

### BRIEF DESCRIPTION OF DRAWINGS

FIG. 1 illustrates, by way of example, a conceptual circuit diagram of an embodiment of a Cooley-Tukey (CT) butterfly operator circuit.

FIG. 2 illustrates, by way of example, a conceptual circuit diagram of an embodiment of a Gentleman-Sande (GS) butterfly operator circuit.

FIG. 3 illustrates, by way of an example, a circuit diagram of a general purpose butterfly operator circuit.

FIG. 4 illustrates, by way of example, a diagram of an embodiment of an architecture for performing number theoretic transform (NTT)/inverse NTT (INTT) at a polynomial level and stage level.

FIG. 5 illustrates, by way of example, a diagram of an embodiment of a scalable NTT/INTT circuit.

FIG. 6 illustrates, by way of example, a diagram of an embodiment of a data flow for an NTT computation of an 8-point polynomial using CT butterfly operations.

FIG. 7 illustrates, by way of example, a graph of implementation results of operations of the circuit for a polynomial of degree 256.

FIG. 8 illustrates, by way of example, a block diagram of an embodiment of a method for synthesizing a circuit for converting polynomial coefficients into or out of a number theoretic transform (NTT) domain.

FIG. 9 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

Lattice-based cryptosystems are among the most promising post-quantum computer (PQC) algorithms that are believed to be hard for both classical and quantum computers. Number Theoretic Transform (NTT) and inverse NTT (INTT) are used to achieve more efficient polynomial multiplication in lattice-based cryptosystems by reducing time-complexity from O(n²) to O(n log n). Embodiments include a circuit architecture that can include multi-levels of parallelism. The parallelism helps accelerate the NTT/INTT computation on reconfigurable hardware. Embodiments can allow a designer to explore different design spaces. Embodiments can allow a designer to explore trade-offs on hardware platforms for different NTT/INTT configurations. Embodiments can use one or more of various optimization techniques, including multi-levels of parallelism, designing reconfigurable cores, and implementing interleaved and pipelined architecture. Embodiment can achieve significant speedup as compared to prior NTT and INTT computation techniques. Embodiments can achieve the speedup while maintaining high security and scalability.

NTT and INTT operations can be accomplished iteratively. NTT and INTT can be performed by applying a sequence of “butterfly operations” on the input polynomial coefficients. Butterfly operations are arithmetic operations that combine two coefficients of polynomials to obtain two outputs. The NTT and INTT operations can be computed in a logarithmic number of steps using repeated butterfly operations.

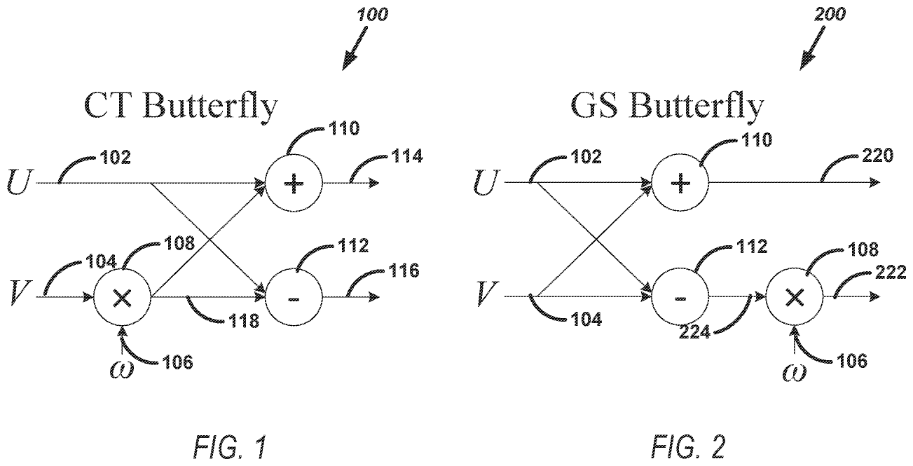

In embodiments, Cooley-Tukey (CT) and Gentleman-Sande (GS) butterfly configurations can be used to facilitate NTT/INTT computation. A commonly required bit-reverse function reverses the bits of the coefficient index. However, the bit-reverse permutation can be skipped by using CT butterfly operations for NTT and GS butterfly operations for INTT. FIGS. 1 and 2 illustrate a CT butterfly operator and the GS butterfly operator, respectively. More details regarding NTT/INTT and lattice-based computation of NTT/INTT are provided elsewhere herein.

FIG. 1 illustrates, by way of example, a conceptual circuit diagram of an embodiment of a CT butterfly operator circuit 100. The circuit 100 performs the mathematical operations the CT butterfly operation. The circuit 100 takes, as input U 102 and V 104, which are coefficients of respective polynomials, and ω 106, which is a weight. V 104 and ω 106 are modular multiplied (V mod q*ω) using a multiplier 108. A result 118 of the multiplication performed by the multiplier 108 and U 102 are added using an adder 110 to generate a first output coefficient 114. The result 118 and U 102 are subtracted using a subtractor 112 to generate a second output coefficient 116. The first and second output coefficients 114 and 116 can then be used as inputs in a next iteration of circuit 100 operation.

Pseudocode for an iterative NTT operation using the CT butterfly operator circuit 100 is provided:

In-Place NTT Algorithm using CT Butterfly Operator Circuit

| Require: a(x) ∈ R_{q}, ωₙ ∈ [symbol] _{q}, n = 2^{l} | |
|---|---|
| Ensure: â(x) = NTT(a) ∈ R_{q} | |
| 1: | â ← bit − reverse(a) |
| 2: | for i from 1 to l do |
| 3: | m = 2^{l-i} |
| 4: | for j from 0 to 2ⁱ⁻¹−1 do |
| 5: | W ← ωₙ^{1+j} |
| 6: | for k from 0 to m−1 do |
| 7: | U ← â[2jm + k] |
| 8: | V ← â[2jm + k + m] mod q |
| 9: | T ← V · W |
| 10: | â[2jm + k] = U + T mod q |
| 11: | â[2jm + k + m] = U − T mod q |
| 12: | end for |
| 13: | end for |
| 14. | end for |
| 15. | return â(x) ∈ R_{q} |

FIG. 2 illustrates, by way of example, a conceptual circuit diagram of an embodiment of a GS butterfly operator circuit 200. The circuit 200 performs the mathematical operations the GS butterfly operation. The circuit 200 takes, as input U 102, V 104, and ω 106. U and V are added mod q, by modular adder 110, resulting in a first output coefficient 220. U 102 and V 104 are subtracted mod q, by modular subtractor 112, resulting in result 224. The result 224 is then multiplied by a weight, ω 106, using a modular multiplier 108. A result of the multiplication performed by the multiplier 108 is a second output coefficient 222. The first and second output coefficients 220 and 222 can then be used as inputs in a next iteration of circuit 200 operation.

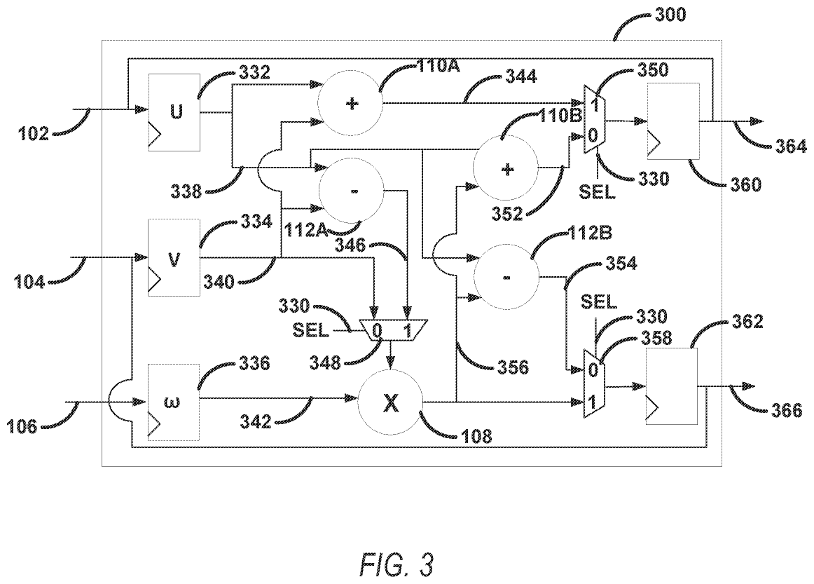

FIG. 3 illustrates, by way of an example, a circuit diagram of a general purpose butterfly operator circuit 300. The circuit 300 can perform CT butterfly operations or GS butterfly operations based on the state of a select signal 330. The circuit 300 as illustrated includes modulo adders 110A, 110B, modulo subtractors 112A, 112B, registers 332, 334, 336, 360, 362, multiplexers 348, 350, 358, and a modulo multiplier 108. The circuit 300 while operating in CT mode is described, followed by description of the circuit 300 while operating in GS mode. When in CT mode, the select signal 330, in the example of FIG. 3, is set to zero (0). The logic of the select signal is not important and the select signal could equivocally be one (1) to place the circuit 300 into CT mode.

In either CT or GS mode, registers 332, 334, 336 store U 102, V 104, and W 106, respectively. On a next clock cycle, each of the registers 332, 334, 336 will provide new outputs 338, 340, and 342, respectively, to the adder 110A, 110B, subtractor 112A, 112B, multiplexer 348, and multiplier 108. In CT mode, the adder 110A and the subtractor 112A are not relevant. Likewise, in GS mode, the adder 110B and the subtractor 112B are not relevant. Thus, the circuit 300 can be implemented with a single adder and a single subtractor. The circuit 300 is illustrated as including two adders and two subtractors, just for ease of understanding and ease of illustration.

In CT mode, the select signal 330 is zero. The multiplier 108 receives the output of the ω register 336 provides a relevant twiddle factor 342 to the multiplier 108. The multiplexer 348 provides output 340 of the register 334 to the multiplier 108. The multiplier 108 multiplies the inputs to produce result 356.

Adder 110B receives output 338 of the register 332 and the result 356. The adder 110B sums the output 338 and the result 356 and provides a result 352 to the multiplexer 350. The multiplexer 350 provides the result 352 to the output register 360. The output register 360 provides the result 352 as a first coefficient 364 during the next clock cycle.

The result 356 is subtracted, by subtractor 112B, from output 338 of the register 332. A result 354 of the subtraction is provided by multiplexer 358 to output register 362. The register 362 provides the result 354 as a second coefficient 366 during a next clock cycle.

In GS mode, the select signal 330 is one. The multiplier 108 receives the output of the w register 336 which provides a relevant twiddle factor 342. The multiplexer 348 provides output 340 of the subtractor 112A to the multiplier 108. The subtractor 112A determines a difference between the output 338 of the register 332 and the output 340 of the register 334 as result 346. The multiplier 108 multiplies the inputs to produce result 356 which is different from the result when the circuit 300 is in CT mode.

Adder 110A receives output 338 of the register 332 and output 340 of the register 334. The adder 110A sums the outputs 338 and 340 and provides a result 344 to the multiplexer 350. The multiplexer 350 provides the result 344 to the output register 360. The output register 360 provides the result 344 as a first coefficient 364 during the next clock cycle.

The result 356 is provided by multiplexer 358 to output register 362. The register 362 provides the result 354 as a second coefficient 366 during a next clock cycle.

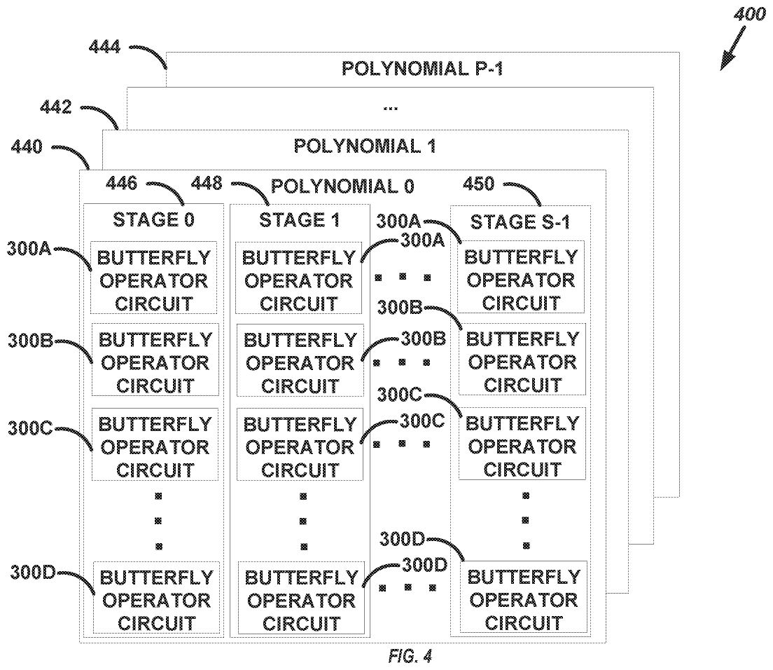

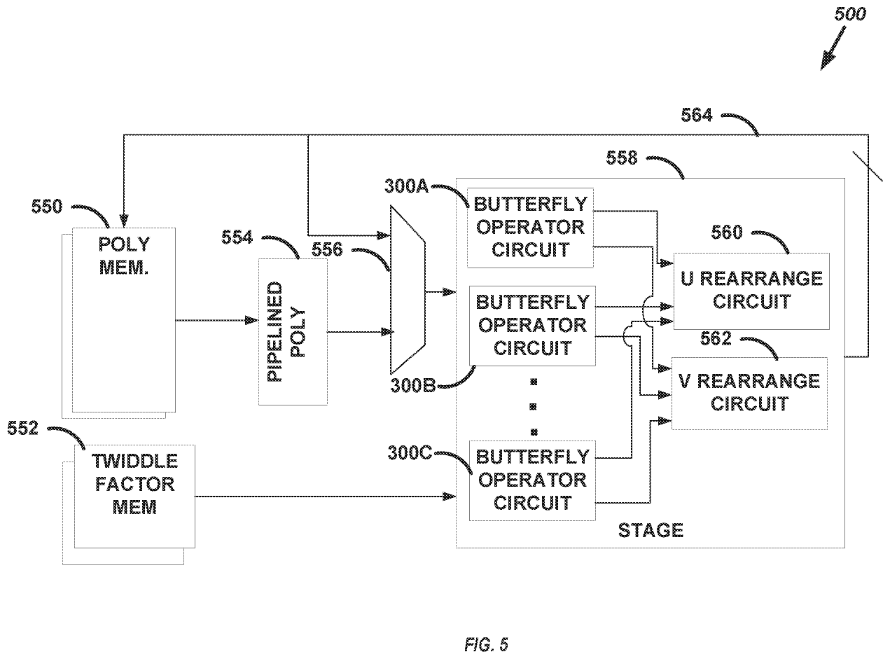

FIGS. 4 and 5 present further details of an architecture of a proposed NTT/INTT operator circuit. The architecture takes advantage of FPGA-based architectural designs exploiting the multi-level of parallelism. The parallel architecture ultimately leads to improvements in the performance and efficiency of the computation. As will be evident, the required NTT/INTT operations can be categorized into three levels, including butterfly core level, stage level, and polynomial level (from inner to outer), respectively. Embodiments can optimize computation at one or more of the levels with a different technique as follows:

1) Butterfly Core Level: A reconfigurable butterfly core is proposed to support both CT and GS operations, which are used for NTT and INTT, respectively, such as to employ resource-sharing techniques and avoid the bit-reverse cost in polynomial multiplication. To perform an NTT over a polynomial of degree n, n/2 independent butterfly operations per stage are performed. These butterfly operations can be performed in parallel to accelerate NTT operations; however, such parallel operations are challenging due to the memory access pattern, particularly, for resource-constrained platforms.

A circuit, illustrated in FIGS. 4 and 5 can be configured with a selectable number of butterfly operator circuits. This flexibility can be offered using a high level specification (HLS) technique. With this strategy, the user can configure the circuit to have a specified number of butterfly circuits 300. The user can thus be the decision-maker and consider trade-offs between the required resources and performance based on their target applications. The butterfly circuit 300 employs three registers corresponding to each required input and also buffers the results in two output registers. Hence, the latency of the butterfly circuit 300, represented by tcore, is 2 cycles.

2) Stage Level: The NTT computation of a polynomial of degree n includes log n stages of n/2 butterfly circuit 300 operations. The operation of n/2 butterfly circuits 300 provides n results since each butterfly circuit 300 provides 2 outputs. The number of stages is thus S=log n. Each of the stages uses output of the preceding stage as its input. Memory access to output of the previous result is thus an important potential bottleneck in stage level implementation. This is, at least in part because the memory access pattern varies for each stage. However, NTT has an aligned access pattern, which means the number of consecutive accesses to the polynomial remains constant.

FIG. 4 illustrates, by way of example, a diagram of an embodiment of an architecture 400 for performing NTT/INTT at a polynomial level 440, 442, 444 and stage level 446, 448, 450. There are P polynomials, where P is an integer, and S stages, where S is an integer, shown in FIG. 4. Assuming P has n coefficients, S=log n and the number of circuits 300A, 300B, 300C, 300D in each stage 446, 448, 450 is n/2.

The throughput of the stage level 446, 448, 450 is proportional to the number of butterfly circuits 300A, 300B, 300C, 300D. Let n_{core} be the number of implemented butterfly circuits 300A, 300B, 300C, 300D in the stage level 446, 448, 450. Given full utilization of butterfly cores, 2n_{core} coefficients are transformed in t_{core}.

The architecture 400 uses an interleaved stage architecture with parallel register banks embedded into the butterfly circuit 300. The parallel register banks help avoid memory access limitations during stage 446, 448, 450 setup operations. The registers 332, 334, 336 are illustrated in FIG. 3. Since all butterfly arithmetic is modular mod q, the total memory size to buffer these 2n_{core} coefficients in the stage architecture is 2n_{core}×log q bits. That amount is equal to the throughput of this level. Simultaneously, a reordering operation needs to be performed at the stage 446, 448, 450 level. A multiplexer structure (e.g., U rearrange circuit and V rearrange circuit) can be used to rearrange the coefficients and pass the coefficients to the next stage. However, these multiplexers result in increasing resource consumption due to the route and placement complexity of the design.

To reduce the required hardware resources, the stage 446, 448, 450 architecture can re-use the same butterfly circuits 300A, 300B, 300C, 300D in each stage 446, 448, 450. That is, the polynomial coefficients can be fed into butterfly circuits 300A, 300B, 300C, 300D in the first stage 446. The results from the first stage 446 are fed as input into the second stage 448, and so on until the final stage produces results that will be stored. Eq. 5 shows the required latency, t_{stage}, for each stage iteration:

$${t}_{stage} = n * \frac{{t}_{core}}{2 {n}_{core}}$$

The computation of an NTT takes t_{NTT} time to complete:

$${t}_{NTT} = {n}_{stage} \times {t}_{stage} = n * logn * \frac{{t}_{core}}{2 {n}_{core}}$$

FIG. 4 illustrates the NTT/INTT operation circuit at a polynomial level. Most lattice-based applications require performing NTT/INTT computation of a vector/matrix of polynomials. The NTT/INTT operations for each polynomial can be performed independently. While most existing implementations use an iterative process to compute an n_{poly} number of polynomials, embodiments can use a pipelined architecture to enhance the architecture, such as from a utilization factor perspective. Using the pipelined design ensures utilization of the stage architecture by feeding coefficients of a next polynomial at the last stage of the previous one. Hence, NTT computation of n_{poly} polynomials can be performed in time, t_{poly}, as:

t_{poly}=n_{poly}×t_{NTT}=n_{poly}*n*log n*t_{core}/2n_{core}

FIG. 5 illustrates, by way of example, a diagram of an embodiment of a scalable NTT/INTT circuit 500. The circuit 500 as illustrated includes a stage 558, which is an example of one of the stages 446, 448, 450 and is illustrated in more detail than in FIG. 4. The stage 558 is re-used in each iteration of determining coefficients for a polynomial in NTT domain or for determining the inverse coefficients in performing an INTT operation. The circuit 500 as illustrated includes a polynomial memory 550, a twiddle factor memory 552, a pipelined polynomial circuit 554, a multiplexer 556, and the stage 558.

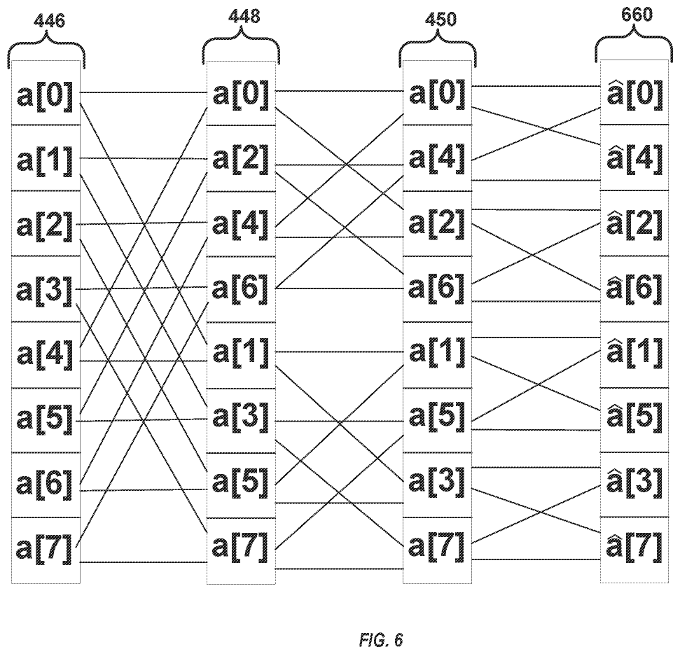

The polynomial memory 550 stores coefficients of polynomials to be converted to the NTT domain and converted back from the NTT domain. The pipelined polynomial circuit 554 includes circuitry to organize input from the polynomial memory 550. The pipelined polynomial circuit 554 organizes the input so that the butterfly operator circuits 300A, 300B, 300C receive the correct input coefficients. The pipeline polynomial circuit 554 provides the relevant coefficients to the multiplexer 556. See FIG. 6 for an explanation of the polynomial coefficient order. The multiplexer 556 selects either output 564 of a prior iteration or output of the pipelined polynomial circuit 554 as input to the stage 558. The output of the pipelined polynomial circuit 554 is provided in a first iteration of a given NTT conversion operation and the output 564 of the stage 558 is provided in the remaining iterations of the given NTT conversion until the final coefficients are determined. Assuming i number of iterations, the output of pipeline polynomial circuit 554 is provided for i=1 and the output 564 of the stage 558 is provided for iterations [2, . . . , i].

The twiddle factor memory 552 provides the proper twiddle fact, w, for each butterfly operator circuit 300A, 300B, 300C. The butterfly operator circuits 300A, 300B, 300C are described regarding FIG. 3. Output from the butterfly operator circuits 300A, 300B, 300C are rearranged by U rearrange circuit 560 and V rearrange circuit 562. Each of the rearrange circuits 560, 562 include multiplexers, switches, or the like configured to alter an order of the coefficients produced by the stage 558. The rearrange circuits 560, 562 can organize the coefficients so that the butterfly operator circuits 300A, 300B, 300C receive the coefficients in proper order to compute the NTT.

What follows is a description of NTT/INTT. Let q be a prime number and [symbol] _{q} be the ring of integers modulo q. Define the ring of polynomials for some integer N as R_{q}= [symbol] _{q}[X]/(X^{N}+1), where the polynomials have n coefficients, each modulo q. Regular font lowercase letters (a) represent single polynomials, bold lowercase letters (a) represent polynomial vectors, and bold uppercase letters (A) to represent a matrix of polynomials. Representations in the NTT domain are represented by (â), (â) and (Â), respectively. Let a and b be polynomial vectors in R_{q}. Let a∘b∈R_{q} denote coefficient-wise multiplication of polynomials. The ∘ product of a matrix and a vector is the natural extension of coefficient-wise multiplication of the polynomial vectors.

A naive method of polynomial multiplication has O(n²) complexity. This complexity can be reduced by using NTT. To multiply two polynomials efficiently in lattice-based cryptography, the polynomial rings of the form R_{q}= [symbol] _{q}[X]/(X^{N}+1) can be used, where (X^{N}+1) enables fast polynomial division. The NTT transform maps polynomials to the NTT domain at the cost of O(n*log n) where multiplying their coefficients results in a polynomial that corresponds to the product of the original polynomials modulo q and (X^{N}+1). Coefficient-wise multiplication has a complexity of O(n). A total time complexity is thus O(n·log n).

The NTT is a generalization of a fast Fourier transform (FFT) defined in a finite field. Suppose f is a polynomial of degree n with coefficients in [symbol] _{q}, as:

$$f = {\sum }_{i = 0}^{n - 1} {f}_{i} {X}^{i}$$

FFT uses the twiddle factor con n-th root of unity of form e^{2πj/n}, while NTT has ωₙ∈ [symbol] _{q} such that ωₙ be a primitive n-th root of unity modulo q, i.e. ωₙⁿ=1 mod q. The NTT transforms f, i.e., \hat{f}=NTT(f), is computed as follows for each i∈{0, 1, . . . , n−1}:

$${\hat{f}}_{i} = {\sum }_{j = 0}^{n - 1} {f}_{j} {ω}_{n}^{ij}$$

The INTT recovers f from \hat{f} as:

$${f}_{i} = {\sum }_{j = 0}^{n - 1} {\hat{f}}_{j} {ω}_{n}^{- ij}$$

Hence, the multiplication between two polynomials f and g using NTT can be performed as:

f·g=INTT(NTT(f)∘NTT(g))

NTT algorithm is shown in pseudocode elsewhere herein.

FIG. 6 illustrates, by way of example, a diagram of an embodiment of a data flow for an NTT computation of an 8-point polynomial using CT butterfly operations. The multiplexers of the U rearrange circuit 5?? and the V rearrange circuit 5?? handle the data flow between iterative operations performed by each stage. At a first stage 446, the 8 coefficients are provided. Four butterfly circuits 300 can operate in parallel on the 8 coefficients. In a first stage 446, a first butterfly circuit receives a least significant coefficient (constant or [a[0] or the first coefficient) and a fifth coefficient (a[4], the coefficient of x⁴ in the polynomial) and produces the least significant coefficient (the 1^{st} coefficient) and the second least significant coefficient (the 2^{nd} coefficient, a[I]) for a next stage 448. In the first stage 446, the second butterfly circuit receives the second coefficient (a[1]) and a sixth coefficient (a[5], the coefficient of x³ in the polynomial) and produces the third coefficient (a[2]) and the fourth coefficient (a[4]) for the next stage 448. In the first stage 446, the third butterfly circuit receives the third coefficient (a[2]) and a seventh coefficient (a[6], the coefficient of x⁶ in the polynomial) and produces the fifth coefficient (a[4]) and the fourth coefficient (a[5]) for the next stage 448. In the first stage 448, the fourth butterfly circuit receives the fourth coefficient (a[3]) and an eighth coefficient (a[7], the coefficient of x⁷ in the polynomial) and produces the seventh coefficient (a[6]) and the eighth coefficient (a[7]) for the next stage 448. Three more stages operate to generate the final coefficients 660 that represent the polynomial with coefficients a[i] in the NTT domain.

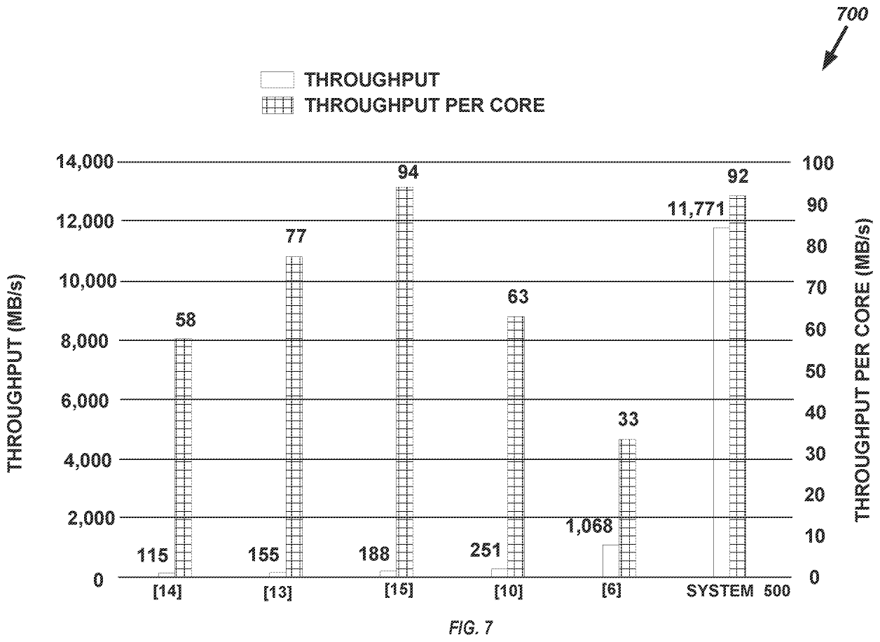

FIG. 7 illustrates, by way of example, a graph 700 of implementation results of operations of the circuit 500 for a polynomial of degree 256, i.e., n=256. To have a fair comparison, the performance is reported in terms of throughput in MB/s to consider different data path widths. The number of cores, n_{core}=128, for the graph results. With this implementation t_{stage}=2 cycles. Hence, an NTT computation takes only 14 cycles, i.e., t_{NTT}=14 cycles.

The results shows the NTT architecture of FIG. 5 achieves a throughput of 11,771 MB/s using 128 butterfly circuits, while each circuit provides 92 MB/s on average. The proposed HLS-based butterfly circuit performance results are comparable to the hand-optimized core proposed in [15] which refers to V. B. Dang, K. Mohajerani, and K. Gaj, “High-speed hardware architectures and FPGA benchmarking of crystals-kyber, ntru, and saber,” IEEE Trans. Computers, vol. 72, no. 2, pp. 306-320, 2023., while outperforming other architectures in [10] which refers to M. Bisheh-Niasar, R. Azarderakhsh, and M. M. Kermani, “High-speed ntt-based polynomial multiplication accelerator for post-quantum cryptography,” in 28th IEEE Symposium on Computer Arithmetic, ARITH 2021 Lyngby, Denmark, Jun. 14-16, 2021, pp. 94-101, IEEE, 2021; [13] which refers to M. Bisheh-Niasar, R. Azarderakhsh, and M. M. Kermani, “Instruction set accelerated implementation of crystals-kyber,” IEEE Trans. Circuits Syst. I Regul. Pap., vol. 68, no. 11, pp. 4648-4659, 2021 (“M. Bisheh-Niasar et al”); and [14] which refers to Y. Xing and S. Li, “A compact hardware implementation of cca-secure key exchange mechanism CRYSTALS-KYBER on FPGA,” IACR Trans. Cryptogr. Hardw. Embed. Syst., vol. 2021, no. 2, pp. 328-356, 2021. Compared to HLS-based NTT design in [6] which refers to A. C. Mert, E. Karabulut, E. O ztu\ddot{ }rk, E. Savas, and A. Aysu, “An extensive study of flexible design methods for the number theoretic transform,” IEEE Trans. Computers, vol. 71, no. 11, pp. 2829-2843, 2022 (“Mert et al.), embodiments can achieve almost 3× speedup per butterfly circuit.

Taking advantage of an optimized and scalable NTT architecture with multi-level parallelism, embodiments show a significant improvement. Embodiments can achieve 11X more throughput at the cost of around 4× resources compared to Mert et al. Hence, our architecture approximately improves 63% efficiency for NTT computation. For hand-optimized RTL design, the most high-performance design is presented by Bisheh-Niasar et. al. in M. Bisheh-Niasar et al with a merged NTT layer, while embodiments outperform that design by almost 46× speedup.

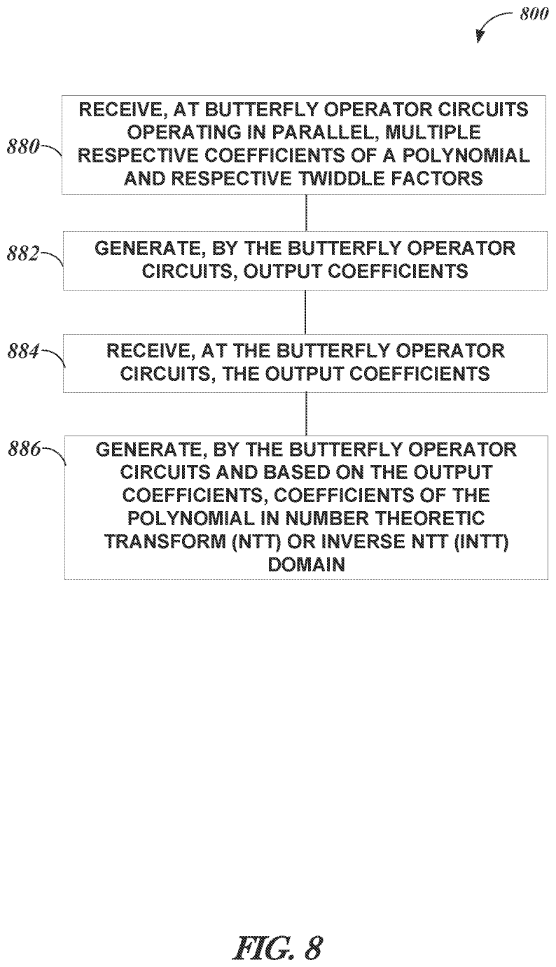

FIG. 8 illustrates, by way of example, a block diagram of an embodiment of a method 800 for efficient conversion of a polynomial into or out of NTT domain. The method 800 as illustrated includes receiving, at butterfly operator circuits operating in parallel, multiple respective coefficients of a polynomial and respective twiddle factors, at operation 880; generating, by the butterfly operator circuits and based on the respective coefficients of the polynomial and the respective twiddle factors, output coefficients, at operation 882; receiving, at the butterfly operator circuits, the output coefficients, at operation 884; and generating, by the butterfly operator circuits and based on the output coefficients, coefficients of the polynomial in NTT domain, at operation 886. The butterfly operator circuits can be configured as CT butterfly operator circuits for conversion of the coefficients of the polynomial to NTT domain or GS butterfly operator circuits for conversion of the coefficients of the polynomial out of the NTT domain.

The method 800 can further include before receiving the output coefficients, rearranging, by a rearrange circuit, an order of the output coefficients to alter which of the butterfly operator circuits receives one or more of the output coefficients. The polynomial can have n coefficients and there can be n/2 butterfly operator circuits operating in parallel. Each butterfly operator circuit can receive a first coefficient of the respective coefficients from a respective (e.g., local) first register. “Local” means directly connected to the butterfly operator circuit in this context. Each butterfly operator circuit can receive a second coefficient of the respective coefficients from a respective (e.g., local) second register. Each butterfly operator circuit can receive a respective twiddle factor of the twiddle factors from a respective (e.g., local) third register. The method 800 can further include providing, by a multiplexer and based on a select control of the multiplexer, the respective coefficients of the polynomial or the output coefficients.

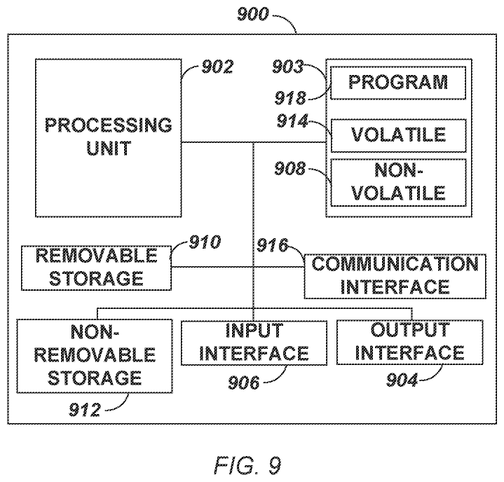

FIG. 9 illustrates, by way of example, a block diagram of an embodiment of a machine 900 (e.g., a computer system) to implement one or more embodiments. The machine 900 can implement a technique for. Any of the CT butterfly operator circuit 100, GS butterfly operator circuit 200, configurable butterfly operator circuit 300, stage 446, 448, 450, polynomial memory 550, twiddle factor memory 552, pipelined polynomial circuit 554, multiplexer 556, stage 558, rearrange circuit 560, 562, method 800 or a component or operation thereof can include one or more of the components of the machine 900. One or more of the CT butterfly operator circuit 100, GS butterfly operator circuit 200, configurable butterfly operator circuit 300, stage 446, 448, 450, polynomial memory 550, twiddle factor memory 552, pipelined polynomial circuit 554, multiplexer 556, stage 558, rearrange circuit 560, 562, method 800, or a component or operations thereof can be implemented, at least in part, using a component of the machine 900. One example machine 900 (in the form of a computer), may include a processing unit 902, memory 903, removable storage 910, and non-removable storage 912. Although the example computing device is illustrated and described as machine 900, the computing device may be in different forms in different embodiments. For example, the computing device may instead be a smartphone, a tablet, smartwatch, or other computing device including the same or similar elements as illustrated and described regarding FIG. 9. Devices such as smartphones, tablets, and smartwatches are generally collectively referred to as mobile devices. Further, although the various data storage elements are illustrated as part of the machine 900, the storage may also or alternatively include cloud-based storage accessible via a network, such as the Internet.

Memory 903 may include volatile memory 914 and non-volatile memory 808. The machine 900 may include—or have access to a computing environment that includes—a variety of computer-readable media, such as volatile memory 914 and non-volatile memory 908, removable storage 910 and non-removable storage 912. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 900 may include or have access to a computing environment that includes input 906, output 904, and a communication connection 916. Output 904 may include a display device, such as a touchscreen, that also may serve as an input device. The input 906 may include one or more of a touchscreen, touchpad, mouse, keyboard, camera, one or more device-specific buttons, one or more sensors integrated within or coupled via wired or wireless data connections to the machine 900, and other input devices. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 902 (sometimes called processing circuitry) of the machine 900. A hard drive, CD-ROM, and RAM are some examples of articles including a non-transitory computer-readable medium such as a storage device. For example, a computer program 918 may be used to cause processing unit 902 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like).

### Additional Notes and Examples

Example 1 includes a method comprising receiving, at butterfly operator circuits operating in parallel, multiple respective coefficients of a polynomial and respective twiddle factors, generating, by the butterfly operator circuits and based on the respective coefficients of the polynomial and the respective twiddle factors, output coefficients, receiving, at the butterfly operator circuits, the output coefficients, and generating, by the butterfly operator circuits and based on the output coefficients, coefficients of the polynomial in NTT domain or out of NTT domain.

In Example 2, Example 1 further includes, wherein the butterfly operator circuits are configured as Cooley-Tukey (CT) butterfly operator circuits or Gentleman-Sande (GS) butterfly operator circuits.

In Example 3, at least one of Examples 1-2 further includes before receiving the output coefficients, rearranging, by a rearrange circuit, an order of the output coefficients to alter which of the butterfly operator circuits receives one or more of the output coefficients.

In Example 4, at least one of Examples 1-3 further includes, wherein the polynomial has in coefficients and there are n/2 butterfly operator circuits.

In Example 5, at least one of Examples 1-4 further includes, wherein each butterfly operator circuit receives a first coefficient of the respective coefficients from a respective first register, a second coefficient of the respective coefficients from a respective second register, and a respective twiddle factor of the twiddle factors from a respective third register.

In Example 6, Example 5 further includes, wherein each butterfly operator circuit receives a first output coefficient of the output coefficients from the respective first register, a second output coefficient of the output coefficients from the respective second register, and a respective twiddle factor of the twiddle factors from the respective third register.

In Example 7, at least one of Examples 1-6 further includes providing, by a multiplexer and based on a select control of the multiplexer, the respective coefficients of the polynomial or the output coefficients.

Example 8 includes a device comprising butterfly operator circuits situated in parallel and to receive coefficients of a polynomial, a rearrange circuit configured to receive output of the butterfly operator circuits and route the output to input of the butterfly operator circuits, and a memory situated to receive coefficients corresponding to the polynomial in a different domain that are output from the rearrange circuit.

In Example 9, Example 8 can further include, wherein the different domain includes number theoretic transform (NTT) domain or inverse NTT (INTT) domain.

In Example 10, at least one of Examples 8-9 further includes, wherein each of the butterfly operator circuits further include a first register configured to provide a first coefficient, a second register configured to provide a second coefficient, and a third register configured to provide a twiddle factor.

In Example 11, at least one of Examples 9-10 further includes, wherein there are n polynomial coefficients and n/2 butterfly operator circuits.

In Example 12, at least one of Examples 8-11 further includes, wherein the rearrange circuit rearranges the output differently for different iterations of operating the butterfly operator circuits.

In Example 13, at least one of Examples 8-12 further includes, wherein the butterfly operator circuits each comprise an adder, a subtractor, and a multiplier.

In Example 14, at least one of Examples 9-13 further includes, wherein the butterfly operator circuits each comprise a first multiplexer that, when a control signal is set to NTT mode, provides the second coefficient and, when the control signal is set to inverse NTT (INTT) mode, provides a difference between the first coefficient and the second coefficient.

In Example 15, Example 14 further includes, wherein the butterfly operator circuits each comprise a second multiplexer that, when the control signal is set to the NTT mode, provides a result of multiplying the second coefficient by the twiddle factor and then subtracting the first coefficient and, when the control signal is set to inverse NTT (INTT) mode, provides a result that is a difference between the first coefficient and the second coefficient and then multiplying the difference by the twiddle factor.

In Example 16, Example 15 further includes, wherein the butterfly operator circuits each comprise a third multiplexer that, when the control signal is set to NTT mode, provides a result of multiplying the second coefficient by the twiddle factor and then adding the first coefficient and, when the control signal is set to inverse NTT (INTT) mode, provides a result of adding the first coefficient and the second coefficient.

Example 17 includes a system comprising first butterfly operator circuits situated in parallel and configured to transform first coefficients of a first polynomial in a first domain to coefficients of the first polynomial in a second, different domain, and second butterfly operator circuits situated in parallel and configured to transform second coefficients of a second polynomial in the first domain to coefficients of the second polynomial in the second domain.

In Example 18, Example 17 further includes, wherein each of the butterfly operator circuits further include a first register configured to provide a first coefficient, a second register configured to provide a second coefficient, and a third register configured to provide a twiddle factor.

In Example 19, Example 18 further includes, wherein there are n coefficients in the first and second polynomials and the first and second butterfly operator circuits include n/2 butterfly operator circuits each.

In Example 20, at least one of Examples 17-19 further includes, wherein each of the first and second butterfly operator circuits are coupled to first and second rearrange circuits, respectively, the first and second rearrange circuits are configured to receive output of the butterfly operator circuits and route the output to input of the butterfly operator circuits.

In Example 21, Example 20 further includes, wherein the first and second rearrange circuits rearrange the output differently for different iterations of operating the first and second butterfly operator circuits.

In Example 22, at least one of Examples 17-21 further includes, wherein the butterfly operator circuits of the first and second butterfly operator circuits each comprise an adder, a subtractor, and a multiplier.

In Example 23, Example 22 further includes, wherein the butterfly operator circuits of the first and second butterfly operator circuits each comprise a first multiplexer that, when a control signal is set to NTT mode, provides the second coefficient and, when the control signal is set to inverse NTT (INTT) mode, provides a difference between the first coefficient and the second coefficient.

In Example 24, Example 23 further includes, wherein the butterfly operator circuits of the first and second butterfly operator circuits each comprise a second multiplexer that, when the control signal is set to the NTT mode, provides a result of multiplying the second coefficient by the twiddle factor and then subtracting the first coefficient and, when the control signal is set to inverse NTT (INTT) mode, provides a result that is a difference between the first coefficient and the second coefficient and then multiplying the difference by the twiddle factor.

In Example 25, Example 24 further includes, wherein the butterfly operator circuits of the first and second butterfly operator circuits each comprise a third multiplexer that, when the control signal is set to NTT mode, provides a result of multiplying the second coefficient by the twiddle factor and then adding the first coefficient and, when the control signal is set to inverse NTT (INTT) mode, provides a result of adding the first coefficient and the second coefficient.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method comprising:
receiving, at butterfly operator circuits operating in parallel, multiple respective coefficients of a polynomial and respective twiddle factors;
generating, by the butterfly operator circuits and based on the respective coefficients of the polynomial and the respective twiddle factors, output coefficients;
receiving, at the butterfly operator circuits, the output coefficients; and
generating, by the butterfly operator circuits and based on the output coefficients, coefficients of the polynomial in number theoretic transform (NTT) domain or out of the NTT domain.

2. The method of claim 1, wherein the butterfly operator circuits are configured as Cooley-Tukey (CT) butterfly operator circuits or Gentleman-Sande (GS) butterfly operator circuits.

3. The method of claim 1, further comprising before receiving the output coefficients, rearranging, by a rearrange circuit, an order of the output coefficients to alter which of the butterfly operator circuits receives one or more of the output coefficients.

4. The method of claim 1, wherein the polynomial has in coefficients and there are n/2 butterfly operator circuits.

5. The method of claim 1, wherein each butterfly operator circuit receives a first coefficient of the respective coefficients from a respective first register, a second coefficient of the respective coefficients from a respective second register, and a respective twiddle factor of the twiddle factors from a respective third register.

6. The method of claim 5, wherein each butterfly operator circuit receives a first output coefficient of the output coefficients from the respective first register, a second output coefficient of the output coefficients from the respective second register, and a respective twiddle factor of the twiddle factors from the respective third register.

7. The method of claim 1, further comprising:
providing, by a multiplexer and based on a select control of the multiplexer, the respective coefficients of the polynomial or the output coefficients.

8. A device comprising:
butterfly operator circuits situated in parallel and to receive coefficients of a polynomial;
a rearrange circuit configured to receive output of the butterfly operator circuits and route the output to input of the butterfly operator circuits; and
a memory situated to receive coefficients corresponding to the polynomial in a different domain that are output from the rearrange circuit.

9. The device of claim 8, wherein the different domain includes number theoretic transform (NTT) domain or inverse NTT (INTT) domain.

10. The device of claim 8, wherein each of the butterfly operator circuits further include:
a first register configured to provide a first coefficient;
a second register configured to provide a second coefficient; and
a third register configured to provide a twiddle factor.

11. The device of claim 9, wherein there are n polynomial coefficients and n/2 butterfly operator circuits.

12. The device of claim 8, wherein the rearrange circuit rearranges the output differently for different iterations of operating the butterfly operator circuits.

13. The device of claim 8, wherein the butterfly operator circuits each comprise an adder, a subtractor, and a multiplier.

14. The device of claim 9, wherein the butterfly operator circuits each comprise a first multiplexer that, when a control signal is set to NTT mode, provides the second coefficient and, when the control signal is set to inverse NTT (INTT) mode, provides a difference between the first coefficient and the second coefficient.

15. The device of claim 14, wherein the butterfly operator circuits each comprise a second multiplexer that, when the control signal is set to the NTT mode, provides a result of multiplying the second coefficient by the twiddle factor and then subtracting the first coefficient and, when the control signal is set to inverse NTT (INTT) mode, provides a result that is a difference between the first coefficient and the second coefficient and then multiplying the difference by the twiddle factor.

16. The device of claim 15, wherein the butterfly operator circuits each comprise a third multiplexer that, when the control signal is set to NTT mode, provides a result of multiplying the second coefficient by the twiddle factor and then adding the first coefficient and, when the control signal is set to inverse NTT (INTT) mode, provides a result of adding the first coefficient and the second coefficient.

17. A system comprising:
first butterfly operator circuits situated in parallel and configured to transform first coefficients of a first polynomial in a first domain to coefficients of the first polynomial in a second, different domain; and
second butterfly operator circuits situated in parallel and configured to transform second coefficients of a second polynomial in the first domain to coefficients of the second polynomial in the second domain.

18. The system of claim 17, wherein each of the butterfly operator circuits of the first and second butterfly operator circuits further include a first register configured to provide a first coefficient, a second register configured to provide a second coefficient, and a third register configured to provide a twiddle factor.

19. The system of claim 17, wherein there are n coefficients in the first and second polynomials and the first and second butterfly operator circuits include n/2 butterfly operator circuits each.

20. The system of claim 17, wherein:
the butterfly operator circuits of the first and second butterfly operator circuits each comprise a first multiplexer that, when a control signal is set to NTT mode, provides the second coefficient and, when the control signal is set to inverse NTT (INTT) mode, provides a difference between the first coefficient and the second coefficient;
the butterfly operator circuits of the first and second butterfly operator circuits each comprise a second multiplexer that, when the control signal is set to the NTT mode, provides a result of multiplying the second coefficient by the twiddle factor and then subtracting the first coefficient and, when the control signal is set to inverse NTT (INTT) mode, provides a result that is a difference between the first coefficient and the second coefficient and then multiplying the difference by the twiddle factor; and
the butterfly operator circuits of the first and second butterfly operator circuits each comprise a third multiplexer that, when the control signal is set to NTT mode, provides a result of multiplying the second coefficient by the twiddle factor and then adding the first coefficient and, when the control signal is set to inverse NTT (INTT) mode, provides a result of adding the first coefficient and the second coefficient.
